(19) United States
(12) Patent Application Publication
(10) Pub. No.: US 2011/0061257 A1
(43) Pub. Date: Mar. 17, 2011

(54) Accessory Drying Insert

(76) Inventor: Christopher H. Balsillie, Pismo Beach, CA (US)

(21) Appl. No.: 12/561,263

(22) Filed: Sep. 17, 2009

(51) Int. Cl. F26B 13/26

(52) U.S. Cl. 34/95.2

(57) ABSTRACT

An accessory drying insert system consisting of a flexible cylinder shaped body made of cloth fabric which is filled with reusable desiccant beads. A fabric loop is attached at one end to facilitate removal from object being dried. The cloth wicks the moisture so it is drawn to the desiccant, where the desiccant traps the moisture. The desiccant beads are packed within the cylinder shaped body tight enough to give it shape, but loose enough to make the insert flexible like a bean bag in order to allow for easy installation and removal from the accessory being dried. The flexibility of the insert allows the drying system to be used for a multitude of accessories including boots, shoes, socks, gloves, waders, helmets, hats, gear bags, and sleeping bags. The desiccant beads allow for easy regeneration by placing the insert in direct sunlight, near or on a heat source, or by heating in a microwave oven.

### CROSS-REFERENCE TO RELATED APPLICATIONS

This application claims the benefit of provisional patent Application No. 61/074,672, filed 2008 Jun. 23 by the present inventor.

### FEDERALLY SPONSORED RESEARCH

n/a

### SEQUENCE LISTING OR PROGRAM

n/a

### BACKGROUND OF THE INVENTION

1. Field of Invention

The present invention relates to general use as an apparatus to dry accessories worn on the feet, head, or hands or otherwise damp from human perspiration or water ingression.

2. Description of Prior Art

Moisture build up inside of accessories resulting from human perspiration has been a problem since accessories have been worn or used. Many types of footwear accumulate moisture from perspiration as well as other sources such as groundwater, streams, melting snow, and ocean waves. Moisture accumulation is not only uncomfortable, but also facilitates bacterial and fungus growth.

It is known to remove perspiration moisture during use of the footwear drying insert by employing a elongated foot-shaped body containing a plurality of baffles which contain some desiccant material as exemplified in U.S. Pat. No. 5,542,191. However, while such an insert may be serviceable for drying shoes and boots, it will not work for other accessories because of its shape. It must also be sized correctly to the appropriate shoe or boot in order to fit and be effective. The insert also contains an internal cavity containing a fill which can trap moisture thus harboring bacteria and fungus which can contaminate the footwear. The insert can also contain an internal air bladder which can leak and or rupture thus reducing the inserts lifespan. It is also known to remove moisture during use of a shoe by employing and inner sole having a moisture removing agent, as exemplified in U.S. Pat. No. 2,713,214. However, while this inner sole may be workable for drying some moisture from footwear, it does not allow use for other accessory items such as hats, gloves, and gear bags. Other devices used for moisture removal require heat and/or a constant airstream to the interior of the footwear once the footwear is not is use. Examples of such devices are shown in U.S. Pat. Nos. 2,710,905; 3,417,482; 4,768,293; and 5,003,707. All of these devices all limited in use because of their need for electrical power in order to function. In addition, they are costly, complex and can break down.

### SUMMARY OF THE INVENTION

An object of the present invention is to provide a novel device which removes moisture from the interior of any item in which it is placed, while said item is not in use.

An object of the present invention is to provide a drying device which can fit inside many different accessory items including but not limited to: boots, shoes, socks, gloves, helmets, hats, waders, gear bags and sleeping bags.

Another object of the present invention is to provide a drying device which can easily be regenerated by placing in direct sunlight, near a heat source, or heating in a microwave oven.

Another object of the present invention is to provide a drying device which is of basic construction and use and therefore affordable.

Another object of the present invention is to provide a drying system which will make the dried accessory more comfortable to the user, extend the accessories life, and retard the growth of bacteria and fungus.

Another object of the present invention is to provide a drying system which is simple and safe to use and easy to store without any mechanical parts or need for electrical power.

Another object of the present invention is to provide a drying system which is efficient, effective and noise free.

Another object of the present invention is to provide a drying system device which uses reusable desiccant, allowing the device to be used and reused for an extended period of time.

Another object of the present invention is to provide a device which wicks moisture into the device and traps it, allowing for an extended life of the accessory item being dried.

In accordance with these and other objects evident from the following description of a preferred embodiment of the invention, a flexible cylinder shaped drying insert is provided which includes a semi-porous cloth fabric exterior body filled with silica gel beads or another reusable desiccant which act as the desiccant composition enveloped within the body to give it shape and flexibility for insertion into the accessory to be dried.

By providing a construction in accordance with the present invention, numerous advantages are realized. For example, by providing a accessory drying insert having a flexible cylinder shape, it is possible to fill the resulting compartment with silica gel beads which wick moisture from any accessory which the cylinder can be inserted in to.

Another advantage obtained from the use of the present invention is the ability to regenerate the moisture absorption qualities by placing the invention in direct sunlight, near or on a heat source, or by heating in a microwave oven.

### BRIEF DESCRIPTION OF THE DRAWING FIGURES

The invention is described in detail below with reference to the preferred embodiment illustrated in the attached drawing figures, wherein:

FIG. 1 is a front view of the accessory drying insert constructed in accordance with the preferred embodiment;

FIG. 2 is a side view of the accessory drying insert;

FIG. 3 shows the accessory drying insert inserted into a shoe.

### DETAILED DESCRIPTION OF THE PREFERRED EMBODIMENT

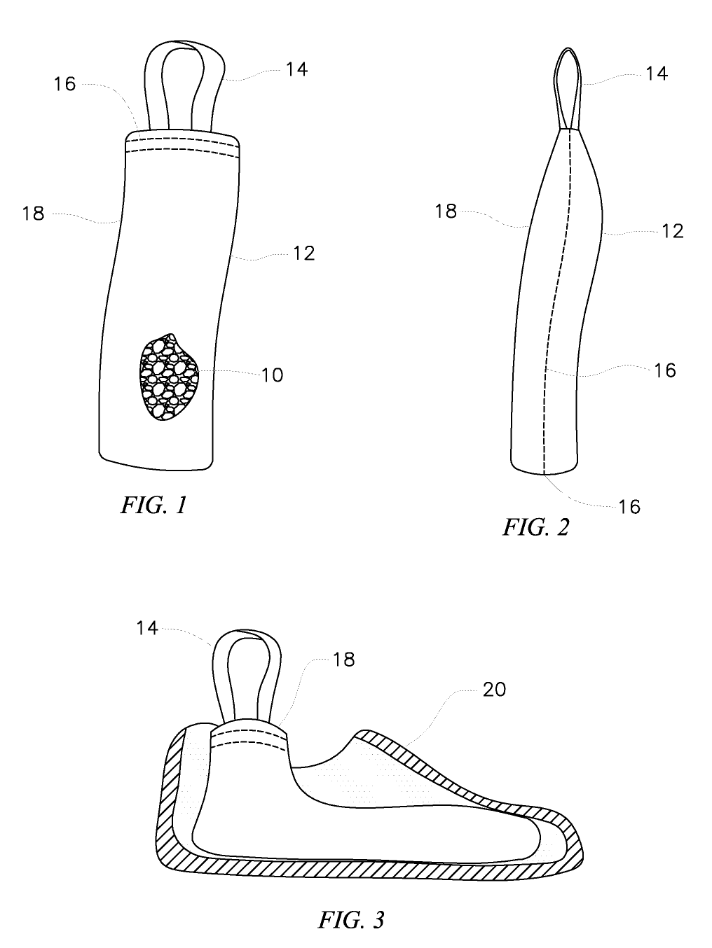

An accessory drying insert 18 constructed in accordance with the preferred embodiment is illustrated in FIG. 1, and is designed for use in removing moisture from an article of apparel such as a ski boot, hiking boot, diver's bootie, tennis shoe, running shoe, roller blade, roller skate, basketball shoe, soccer cleats, baseball cleats, football cleats, gloves, helmets, hats, caps, waders, and other accessories such as gear bags, and sleeping bags.

The insert includes desiccant beads 10 contained within the flexible cylinder shaped fabric sack 12. The desiccant beads 10 allow the sack to be shaped to fit many different articles for drying, much like a bean bag. At one end of the sack 12 is a loop 14 which allows for easy removal from the object being dried 20.

With reference to FIG. 2, the insert 18 is comprised of a cylinder 12 made of semi permeable fabric stitched 16 with thread.

With reference to FIG. 3, the insert 18 is shown as inserted into a shoe 20 with the removal loop 14 in an upright position.

I claim:

1. An accessory drying insert comprising:
A cylinder shaped flexible body which can conform to many shapes for insertion into various articles to be dried;
a reusable bead or granule desiccant filling for the cylinder shaped flexible body so that the insert can be shaped and/or stuffed into the various articles to be dried;
a loop attachment at one end of the insert to provide for easy removal from the various articles dried.
